(19) United States
(12) Patent Application Publication
(10) Pub. No.: US 2024/0206665 A1
(43) Pub. Date: Jun. 27, 2024

(54) PEELING DEVICE FOR A KITCHEN APPLIANCE AND KITCHEN APPLIANCE COMPRISING THE PEELING DEVICE

(71) Applicant: WUNDERMIX GMBH, Garching b. München (DE)

(72) Inventor: Adrian KEUSGEN, Endingen am Kaiserstuhl (DE)

(21) Appl. No.: 18/555,672

(22) PCT Filed: Jul. 25, 2022
(86) PCT No.: PCT/EP2022/070741

§ 371 Date: Oct. 16, 2023

(30) Foreign Application Priority Data
Jul. 26, 2021 (DE) 10 2021 119 339.7
Oct. 6, 2021 (DE) 10 2021 125 978.9
Oct. 14, 2021 (DE) 20 2021 105 578.2

(51) Int. Cl. A47J 17/18; A47J 43/046; A47J 43/07; A47J 43/25; B26D 1/00; B26D 1/29; B26D 3/28

(52) U.S. Cl. CPC A47J 17/18; A47J 43/046; A47J 43/0722; A47J 43/255; B26D 1/0006; B26D 1/29; B26D 3/282

(57) ABSTRACT

A peeling device for insertion in a bowl of an electrical kitchen appliance includes a frame, a grater, and contact surfaces for a drive component of the kitchen appliance which cause the peeling device to rotate during operation of the kitchen appliance. A kitchen appliance with a bowl and a bowl bottom, wherein a cutting component are provided inside the bowl, and further include the peeling device.

### CROSS-REFERENCE TO RELATED APPLICATIONS

This application is a 35 U.S.C. § 371 National Stage patent application of PCT/EP2022/070741, filed on 25 Jul. 2022, which claims the benefit of German patent application 10 2021 119 339.7, filed on 26 Jul. 2021, and claims the benefit of German patent application 10 2021 125 978.9, filed on 6 Oct. 2021, and claims the benefit of German patent application 20 2021 105 578.2, filed 14 Oct. 2021, the disclosures of all of which are incorporated herein by reference in their entirety.

### TECHNICAL FIELD

The present disclosure relates to a peeling device, in particular for vegetables, fruits and potatoes. Furthermore, the disclosure relates to a kitchen appliance comprising such a peeling device.

### BACKGROUND

The peeling of vegetables, fruits and/or potatoes is by its very nature associated with a great deal of effort, at least when this is done by means of a knife. The peeling of potatoes in particular has therefore been facilitated for some time by auxiliary devices, such as potato peelers or special peeling knives. Electric kitchen appliances are also known that can be used, for example, to peel potatoes. The disadvantage is that such a food processor as a further kitchen appliance requires additional space in the kitchen.

### SUMMARY

The disclosure provides a further alternative to known peeling knives or peeling devices. In particular, the peeling device should allow a peeling as easily and quickly as possible.

This is achieved by providing a peeling device having the features of the independent claim and a kitchen appliance having the features of an additional claim.

The peeling device is suitable for use as an insert in a kitchen appliance. This allows the user to peel potatoes or certain types of vegetables and also fruits in the kitchen appliance. The peeling device is placed on drive means of the food processor, for example cutting means or mixing knives. The cutting means transmits the torque via at least one adaptation interface or contact surface to the side of the peeling device facing the cutting means in the inserted state.

In adaptation to the kitchen appliance, the peeling device preferably has a central opening with which it can be placed onto a free end of a drive shaft of the kitchen appliance. The central opening is preferably formed in the center of the peeling device, but can also be formed at other locations. The cutting tools are also mounted on and driven by this drive shaft. In a particularly advantageous embodiment variant, the opening is closed by means of a cup-shaped cover so that the free end of the drive shaft cannot come into contact with the produce to be peeled. Alternatively, it is also possible to provide only a cylindrical section or rim in the region of the opening on the side of the produce to be peeled, which accommodates or surrounds the free portion of the drive shaft so that it does not protrude beyond the section, and only a free front surface of the drive shaft can come into contact with the produce to be peeled. The aforementioned cylindrical section (also called cylinder section) or rim is also used for manual positioning and removal of the peeling device in the bowl of the kitchen appliance by a user.

During the peeling process, the peeling device is supported on the mixing knife in the region of the adaptation interface.

The peeling device has a frame, preferably made of plastics, and a grater. The grater can be made of various suitable materials, preferably sheet metal, plastics or ceramic. The frame and grater can form a single or multi-piece component. In particular, if both components (frame, grater) are made of plastics, a single-piece (one-piece) design can be advantageous. Frame and grater can be made of one and the same plastics. The frame or the grater—if made of plastics—can be produced by injection molding. The same applies in the case where the frame and grater form a one-piece plastic component.

The grater is preferably interchangeable and can be selected to suit the particular produce to be peeled. In the inserted state, the grater is connected to the frame in a rotationally fixed manner. The interchangeable (detachable) attachment of the grater to the frame can be carried out by means of suitable fastening means, for example by one or more snap-in connections, wherein complementary snap-in means are preferably arranged on the frame and the grater in each case. The interchangeability of the grater facilitates the cleaning thereof. In a further configuration, the grater—which can be designed in the manner of a grating disk—can be circumferentially overmolded or coated with plastics at its edge (the grating disk as such being made of metal in this configuration). In this manner, an undesired accumulation of dirt on the grater (grating disk) can be prevented. The mentioned plastic material can have non-stick properties. The surfaces of the grating disk can also be coated or overmolded with a non-stick agent or plastics. The grater comprises grating means arranged on a grating side of the grater, preferably in the form of sharp edges formed on the periphery of openings formed in the grater. The openings can be through openings (holes), which can be arranged in a hole pattern. Thus, the grater can have a plurality of openings (including sharp edges), so-called grating openings. The openings can have any cross-sectional geometry, for example circular, oval, elliptical, polygonal (in particular square, quadrangular, triangular), or in the manner of a parallelogram. The openings are turned up starting from the grating side, i.e. raised with respect to a grating side surface. The protrusions created in this manner can provide the friction means.

Furthermore, the grating means can be designed in the form of structural elements which protrude or project with respect to the surface of the grater (or grating disk) facing the produce to be peeled. The grater can thus be a grating disk with a structured surface, the structured surface being formed by structural elements. The structural elements can have sharp edges. In this configuration, the grater does not necessarily have to have openings.

The mentioned cutting means transmit torque to the peeling device so that the peeling device starts to rotate. As a result, the peel of the produce located on the grater is removed. The peeling device can have a further coupling to be placed on a peeling knife arranged in the bowl of the kitchen appliance, wherein the peeling knife transmits forces/torques to the peeling device. Further, the peeling device can also have a coupling to an assembly of a peeling knife and transmit forces/torques thereto.

The peeling device has a diameter adapted to the bowl of the electric kitchen appliance. Preferably, the peeling device is circular in shape and has a diameter that allows an outer edge of the peeling device to contact an inner wall of the bowl in the inserted state.

The peeling device has a protrusion on its side facing the produce to be peeled, whereby the material is moved, in particular rotated, during the peeling process so that other areas of the produce continuously come into contact with the grater. The produce to be peeled is stirred up by the protrusions as well as by the rotation of the peeling device, whereby all areas on the produce to be peeled can be peeled. The “protrusion” can be formed in the manner of a rib, preferably extending radially from the central opening to the outer edge of the peeling device (or to the frame). The peeling device can have multiple “protrusions”, in particular two, three or any other number of protrusions. Even if there is a plurality of protrusions, they can be formed in a rib-like manner. The protrusions (ribs) can be a one-piece component of the peeling device, which can optionally be formed in one piece. Also, the protrusions (ribs) can be a one-piece component of the grater. Furthermore, the protrusions (ribs) can be attachable to the peeling device or grater. Also, the protrusions (ribs) can be molded to the frame.

The grated peels are transported through openings in the grater to a region of the container located below the peeling device, and settle to the bottom of the container during peeling due to the addition of water.

In a particularly advantageous embodiment variant, the peeling device is compatible with the Thermomix® 5, 6 and 31 kitchen appliances.

### BRIEF DESCRIPTION OF THE DRAWINGS

An exemplary embodiment of the disclosure is shown in the accompanying figures.

FIGS. 1 and 2 show the peeling device 20 in synopsis with a kitchen appliance 30 in which the peeling device can be used. Furthermore, cutting means 40 can be seen, which are arranged within a bowl 50 in the bottom region 100 of the kitchen appliance 30.

FIGS. 3 to 5 show the peeling device 20 in various views (FIG. 3 perspective view from above, FIG. 4 perspective view from below, FIG. 5 side view).

### DETAILED DESCRIPTION OF THE DRAWINGS

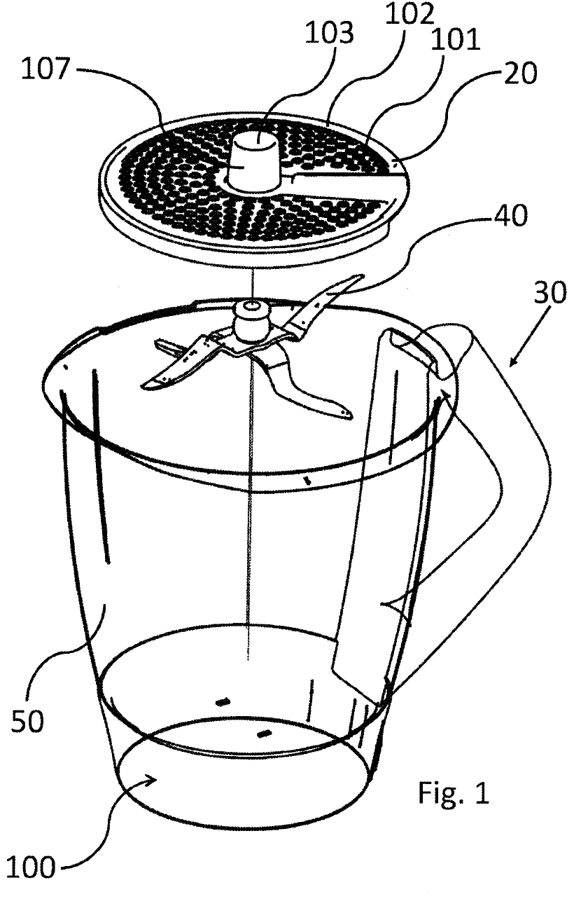

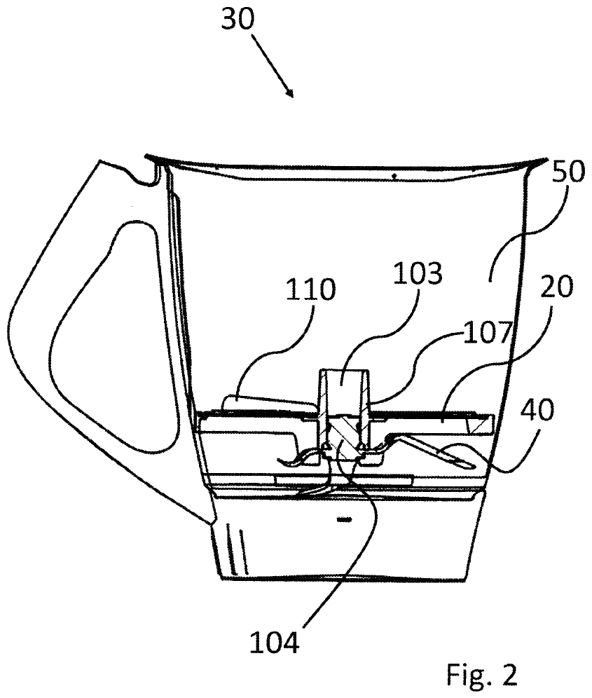

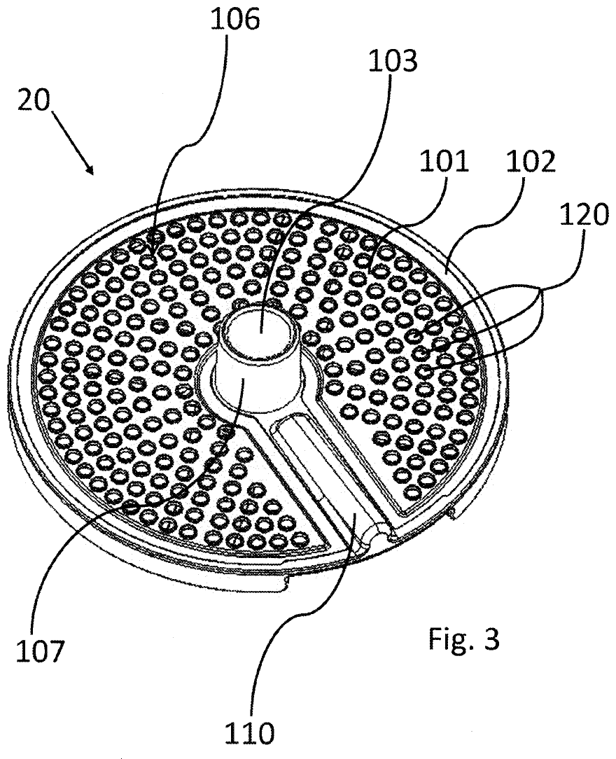

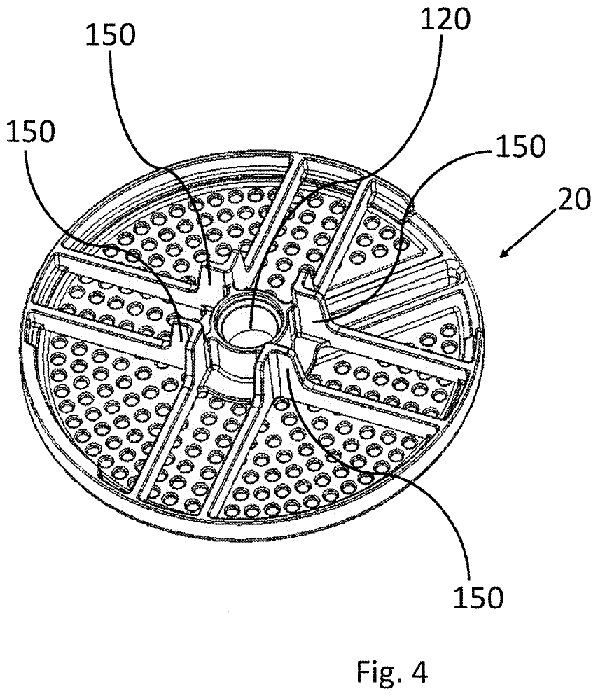

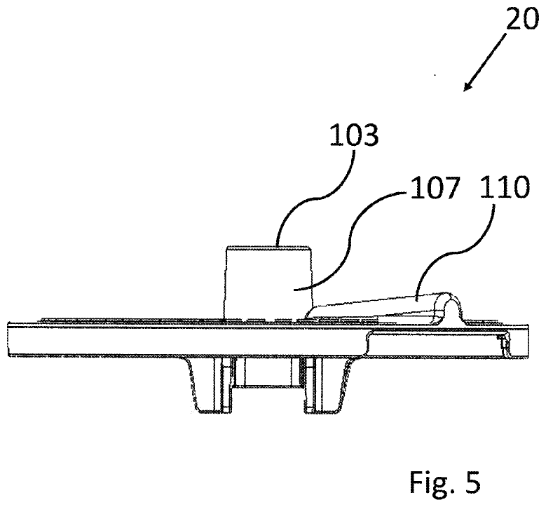

In particular, FIGS. 3 and 4 show a grater 101 (grating disk) arranged in a substantially circular frame 102. Furthermore, a central opening 103 for accommodating the free end 104 of the drive shaft shown in FIGS. 1 and 2 is visible. On a grating side 106 (facing the produce to be peeled in operation) of the grater 101, thus the side facing the produce to be peeled, the central opening 103 is surrounded by a cylinder section 107 which surrounds the free end 104 of the drive shaft extending through the central opening 103 in the fitted state. The cylinder section 107 also serves for manual positioning and removal of the peeling device 20 in the bowl 50 of the kitchen appliance 30.

Furthermore, a protrusion 110 in the form of a rib protruding with respect to a base surface of the grater can be seen, which rotates or moves the produce to be peeled during the rotation of the peeling device 20. The protrusion extends radially outwards from the central opening 103 to the rim 102.

The grater 101 has openings 120 through which pieces of peel can pass into the region below the peeling device 20.

In FIG. 4, the peeling device 20 can be seen from below. In particular, the centrally arranged receptacle 120 for the free end 104 of the drive shaft and the contact surfaces 150 for the radially extending drive means or cutting means 40 (mixing knives) are shown. The cutting means 40 each extend between two contact surfaces 150, so that operation in both directions of rotation is possible.

The hole pattern of the grater 101 shown in the figures, which results from the openings 120, is to be understood to be merely an example and can also be configured differently. Sharp edges, which provide grating means, can be formed on the edges of the openings 120.

1. A peeling device for insertion into a bowl of an electric kitchen appliance, the peeling device comprising: a frame, a grater, and contact surfaces for drive means of the kitchen appliance which cause the peeling device to rotate during operation of the kitchen appliance.

2. The peeling device according to claim 1, wherein the frame and the grater are a one-piece component, or wherein the frame and the grater are separate components.

3. The peeling device according to claim 1, wherein a central opening is provided for accommodating a free end of a drive shaft of the drive means of the kitchen appliance.

4. The peeling device according to claim 1, wherein a protrusion is provided which protrudes with respect to a base surface of the grater and which moves the produce to be peeled during rotation of the peeling device.

5. The peeling device according to claim 4, wherein the protrusion extends radially outwards from a central opening to a rim.

6. The peeling device according to claim 4, wherein the protrusion is formed by an embodiment of the following group:
one-piece component of a peeling device formed in one piece,
one-piece component of the grater,
attachable to the peeling device or grater, or
molded to the frame.

7. A kitchen appliance with a bowl and a bowl bottom, wherein cutting means rotating during operation and extending radially are provided inside the bowl in the region of the bowl bottom, and further including the peeling device according to claim 1.
